(19) United States
(12) Patent Application Publication
(10) Pub. No.: US 2014/0364967 A1
(43) Pub. Date: Dec. 11, 2014

(54) System and Method for Controlling an Electronic Device

(71) Applicant: Scott Sullivan, San Francisco, CA (US)

(72) Inventor: Scott Sullivan, San Francisco, CA (US)

(21) Appl. No.: 14/298,976

(22) Filed: Jun. 9, 2014

Related U.S. Application Data
(60) Provisional application No. 61/832,856, filed on Jun. 8, 2013.

(51) Int. Cl. G05B 15/02; G06F 3/16

(52) U.S. Cl. CPC G05B 15/02; G06F 3/165
USPC 700/83; 700/94

(57) ABSTRACT

For use with a head-worn computer, such as Google's Glass device, a user-generated tooth-tapping based input is used to control various and select computer operations during its use. The user simply opens and closes their jaw slightly so that they tap their right side pair of canine teeth, their left side pair of canine teeth, or all their teeth together to generate a sound and a vibration. This sound and vibration generated by a single tooth tap or any combination thereof is detected by at least one microphone located on the head-worn computer, and according to other embodiments of this invention two or more microphones and/or vibration-detection sensors. The computer receives the tapping sound signals from the microphone and uses controlling circuitry and/an algorithm to determine the exact tap-sequence and time between taps to establish a “command signature”, specific to each particular tap-sequence. From this, the computer compares the command signature with a corresponding command or action stored in the onboard memory and then performs that command or action, as required. The user can effectively and discretely control many operations of the head-worn computer merely through tooth tapping.

### CROSS-REFERENCE TO RELATED APPLICATION

This application claims the benefit of U.S. Provisional Application No. 61/832,856, filed Jun. 8, 2013, entitled “ Dentine-Based Computer Input System and Method for Using Teeth Tapping to Control a Computer.”

### BACKGROUND OF THE INVENTION

1) Field of the Invention

The present invention generally relates to input controllers for controlling the operation of a computer and running applications, and more particularly, to such an input controller for use with head-worn computers, such as the “Google Glass” device.

2) Discussion of Related Art

The trackball input device was invented in 1952 by Tom Cranston. Eleven years later, Douglas Engelbart and Bill English invented the first mouse at the Stanford Research Institute. As is well known, these two devices along with the keyboard would make up for decades to follow the most commonly used input devices for controlling the operation of computers. Other input devices would be introduced along the way including various touchpads, joysticks, eye-movement controllers, gyro-based hand-held controllers, free-form hand gesture input devices, voice command controllers, and touch-screens. Touch-screens led to the development of screen-tapping and finger-swiping gestures, such as what is used to control Apple Computer's iPhone and iPad devices which both use touch-screen displays. Google, Inc. of Mountain View, Calif., has recently introduced a head-worn computer (which resembles a pair of glasses, but currently without the corrective lenses) that uses a heads-up-display (HUD) positioned in front of the user's right eye to communicate visual information to the user, and a bone-conduction transducer positioned against the user's skull near the right ear to communicate audible information to the user. The Google Glass device also includes a microphone for receiving voice commands from the user and an elongated touchpad input device for receiving swiping and tap tactile commands by contact with the user's fingers. The user may input commands to the computer using either voice commands, such as first saying “ok glass” to get its attention and then use the touchpad along the right arm of the frame using their right index finger in different swiping and tapping motions to cause a timeline-like interface displayed on the HUD to scroll past screen-by-screen and also to control and select different options, as they appear and as required.

Although Google's Glass device appears to have opened up a new chapter of really cool and potentially useful smart computing devices, it is not without some operational issues that may be difficult to overcome. For example, many operational commands of the Google device rely on the user's voice to activate. As is well known by users of various “smart” devices, there are many locations and daily situations where a user may find it inappropriate or awkward to voice commands out-loud. These are similar to where cell phone use is discouraged or socially unacceptable and include libraries, hospitals, theaters, classrooms, at a workplace, or just in a crowded area, such as on a subway or bus. The other input device of the Google Glass device relies on the user touching the touchpad located on the right arm of the glasses frame. This may work well for a short while, but if the device requires prolonged input interaction from the user, he or she is going to get real tired real quick holding their hand up against their head as they operate and interactive with their computer device.

### OBJECTS OF THE INVENTION

It is a first object of the invention to provide a new method for inputting commands and controlling the operation of a computer that overcomes the deficiencies of the prior art.

It is a second object of the invention to provide a new method and device for inputting commands and controlling the operation of a head-worn computer, such as Google's Glass device.

It is another object of the invention to provide a head-worn computer that employs a new method for inputting commands and controlling its operation which overcomes the deficiencies of the prior art.

### SUMMARY OF THE INVENTION

For use with a head-worn computer, such as Google's Glass device, a user-generated tooth-tapping input system is used to control various and select computer operations during its operation. In use, the user simply opens and closes their jaw slightly so that he or she taps their right side pair of canine teeth, their left side pair of canine teeth, or all their teeth together to generate unique sounds and vibrations. This sound and vibration generated by a single tooth tap or any combination thereof is detected by at least one microphone located on the head-worn computer, and according to other embodiments of this invention two or more microphones and/or vibration-detection sensors. The computer receives the tapping sound signals from the microphone and uses controlling circuitry and an algorithm to determine the exact tap-sequence and time between taps to establish a “command signature”, that is specific to each particular tap-sequence. From this, the computer compares the command signature with a corresponding command or action stored in the onboard memory and then performs that command or action, as required. The user can effectively and discretely control many operations of the head-worn computer merely through tooth tapping, allowing the device to be used in most, if not all locations and situations. According to another embodiment of this invention, the present tooth-tapping system is used to control music being played through a pair of headphones.

### BRIEF DESCRIPTION OF THE DRAWINGS

FIG. 1 is a left rear perspective view of an exemplary head-mounted computer, according to the prevent invention;

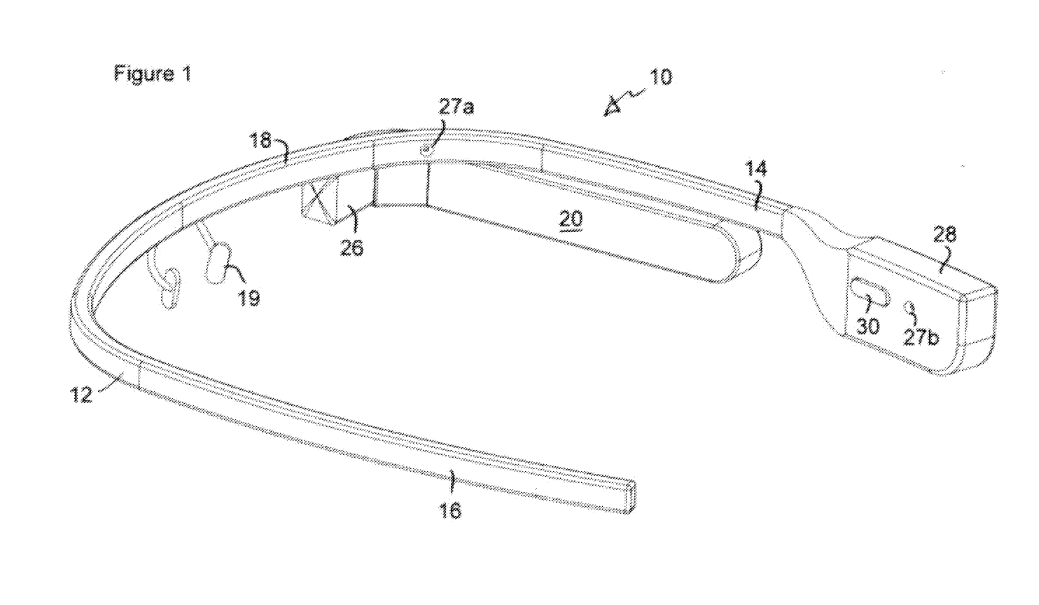

FIG. 2 is a right front perspective view of the exemplary head-mounted computer, according to the prevent invention;

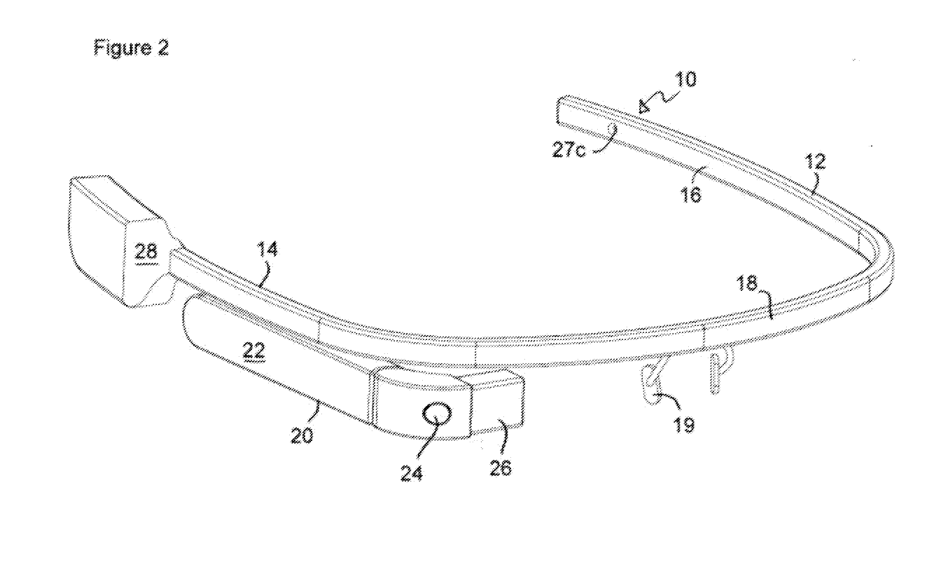

FIG. 3 is a right rear perspective view of the exemplary head-mounted computer, according to the prevent invention;

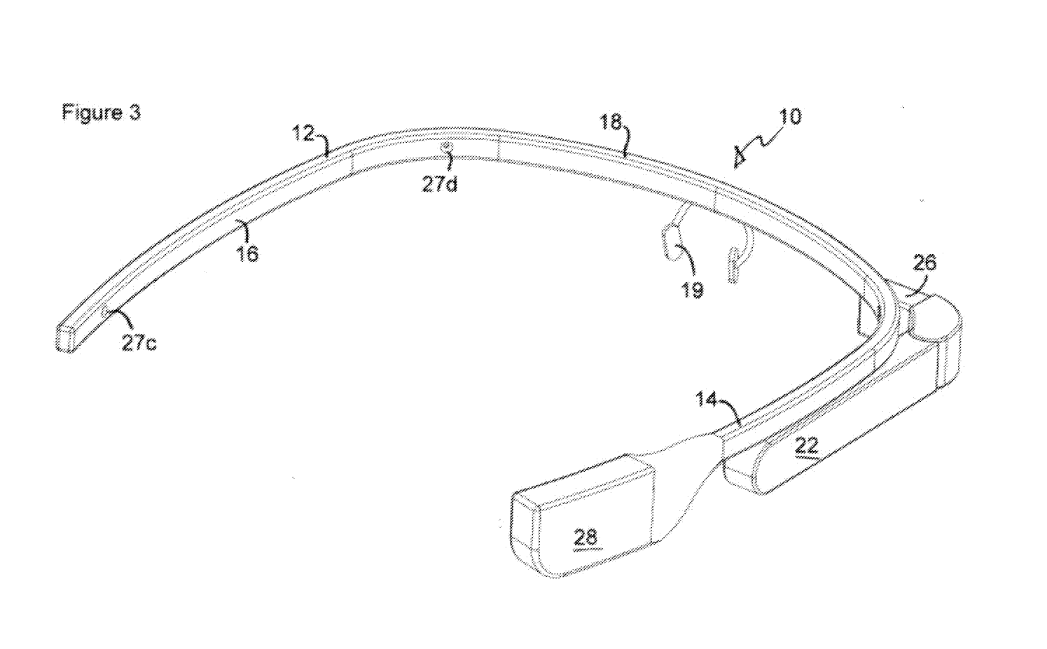

FIG. 4 is a perspective view of a pair of headphones, according to a second embodiment of the invention; and

FIG. 5 is an illustration of a flow schematic, according to the invention.

### DETAILED DESCRIPTION OF THE PREFERRED EMBODIMENTS

Referring to the Figures, an exemplary head-mounted computer device 10, similar to Google's Glass device is shown, including a generally U-shaped frame structure 12 that defines a right arm 14, a left arm 16 and a front member 18. Similar to conventional vision-correction glasses, a generally conventional nose support 19 is secured to front member 18 and is used to comfortably rest on a user's nose to help support device 10 on a user's face. Similarly, right arm 14 and left arm 16 are sized and shaped to comfortably engage the user's ears to help firmly hold frame 12 to the user's head. A first housing 20 is secured to light arm 14 and includes a touchpad input device 22, a camera (and lens) 24, a Heads-Up-Display (HUD) 26, a microphone 27a and other computer-related controlling circuitry and/or batteries (not shown). A second housing 28 is also secured to right arm 14 and includes a bone-conduction transducer 30 and other controlling circuitry and/or batteries (not shown). In some head-mounted computer devices, both housings 20, 28 are in electrical communication with each other so that both housings may contain the necessary components to provide a functional computer. In other head-mounted computer devices 10, a smart phone is required to connect (via Bluetooth, for example) to head-mounted computer device 10 to help perform some or all computing and memory functions. The operational details of head-mounted computer device 10 are similar to a conventional computer and are well known by those skilled in the art and are for the most part beyond the scope of this invention. However, let it be understood that collectively located within first housing 24 and second housing 28 (and in some cases, together with a nearby smart phone) a fully functional computer exists which includes at least a microprocessor, electronic memory, a display driver circuit, and a battery and other controlling circuitry (all not shown).

According to the operation of these commercially available head-mounted devices, such as the Google Glass device, touchpad input device 22 allows a user to input commands to the internal computer components (and in some cases, a nearby smart phone) to control various options and functions of an operating system and/or select computer programs and applications as communicated visually through HUD 26, and effectively audibly (through tactile vibration) by bone-conduction transducer 30, or perhaps a conventional speaker (not shown). For example, the user may operate camera 24 to take a picture by either using a voice command, or by using a finger and touchpad input device 22 and specific touch gestures, as communicated visually through HUD 26. Other applications located within the computer's memory will appear to the user as icons or pages on HUD 26. The user can use touchpad input device 22 and select voice commands to cause the icons or pages to sweep across the field of view of the user through HUD 26 and then further to select options, as necessary to run particular applications, as understood those skilled in the art. Unfortunately, as mentioned above, there are times when the user cannot freely voice commands to microphone 27a and prolonged use of the user's hand and fingers to input commands can be exhausting and awkward. Also, even in situations and locations where the user can voice commands or use finger gestures to control the head-worn computer, these commands are not confidential, and in the case of the voice commands, can be quite revealing and perhaps embarrassing to the user.

According to the present invention, the user uses teeth tapping (any teeth, but preferably the canine, or eye teeth) as an input device. The user selectively taps their right and left side pairs of canine teeth together to create a consistent and repeatable vibration and sound that can be detected by either microphone 27a alone, bone-conduction transducer 30 alone, or both working together, to input select commands to the computer. As shown in the below table, the user can tap either the left or right upper and lower canine teeth once, or twice in quick succession, or even three times in a row to instruct the computer to follow specific commands and perform specific program actions. The user can also create tapping sequences that include different combinations of both left and right tooth taps tap to create other different commands, functions, and selections (either preset, such as opening a new program, or dynamic, making selections from a newly provided list shown on the display). Other combinations of tapping of the right and left canine teeth, changing the intensity of the tap (a soft gentle tap or a hard loud tap), controlling the speed between taps and tapping both sides of the jaws down simultaneously can create even more distinct commands and program actions. The permutations are certainly not endless, but there are quite a few that could prove useful in controlling a head-mounted computer. Even if the user only taps one side of his or her teeth, the generated click sound could still be used to control many functions and make selections. For example, since a human has the ability to tap their teeth very quickly, consistently and for long periods of time generally without fatigue, the user can generate one-side tap sequences to either control many computer operations and make selections in running applications, or work with other input devices to do the same to help improve their computer interaction experience or perhaps make their computer work more efficient.

This tooth tapping action is somewhat similar to the clicking action of two buttons located on a conventional computer mouse, where the user can click different combinations at different speeds to cause the computer to respond differently, and predictably. Applicant has recognized during testing that right and left tooth tapping sounds when recorded have distinctly different pitches when a microphone is positioned on either the right of left side of the user's skull, adjacent the user's right or left ear, respectively. When the tapping sounds are played back, Applicant can audibly identify which taps are from the right side and which are from the left side. Applicant contends that changes in pitch and other unique signal characteristics of sound, including timbre, harmonics, loudness, rhythm, and the main components of a “sound envelope,” of a tooth-tapping sound signal, including attack, sustain and decay between the right and left side teeth-tapping sound can be used to accurately distinguish which side of the user's mouth the sounds were created (left, right and both sides). This sound analysis can be accurately determined using conventional audio electronic circuitry and a suitable microphone, as is well known by those skilled in the art. Applicant also contends that the vibrations generated by teeth tapping can also be detected and used to identify the key signatures between left taps, right taps and both sides tapping simultaneously (i.e., all teeth clenching down together). It is possible, perhaps to use the bone-conduction transducer 30 to receive vibrations from the user tapping his or her teeth, as described above, so that tooth-tapping control could be quickly implemented into a head-mounted computer 10, such as Google's Glass device without any hardware changes or additions—only software changes.

Applicant believes that the different sounds between the left and right canine teeth pairs, as recorded from a single side of the user's head may be attributed to the differences in distance between the left and right canine tooth pair and the common location of the pickup microphone. The different sound characteristics between the sounds generated from left and right sides may also be caused by inherently different tooth and mouth structure, dental work (fillings) and other biological and environmental reasons. Regardless of the reasons why the sound characteristics of tooth tapping from different sides of a user's mouth are different, Applicant proposes a simple learning program to be used that allows the head-mounted computer to register and calibrate the sound signatures generated from left and right side taps, as well as both (all teeth tapping) so that the computer can learn and understand the user's unique input sounds and better identify which side a tapping sound is from and thereby better understand the user's inputted command. The learning process here could be similar to the learning process conventional voice-recognition software employs to learn the particulars of a user's voice.

According to another embodiment of the invention, two or more microphones 27a-d and/or bone-conduction transducers 30 and/or other types of audio or vibration transducers. Elements 27a-d shown in the figures (which are preferably microphones, but can also be other types of sensors used to detect the sound and vibration characteristics of the user tapping their teeth) are positioned at select locations on frame structure 12, preferably a distance from each other or on opposing sides (e.g., one near the user's right ear and another located near the user's left ear) to help distinguish between the right and left tooth taps using well known audible triangulation techniques. Of course, if bone-conduction transducers or other types of vibration transducers are used, according to the present invention, they will likely have to be positioned in direct contact with the user's skin and immediately adjacent to underlying bone, as is well known by those skilled in the art.

Some examples of how tooth tapping can control various functions of head-worn computer 10 (and other smart and electronic devices, such as music players and cell phones) are shown in the below table. Of course, these are just examples to illustrate how useful this form of command input and control is at controlling a head-mounted computer, such as the Google Glass device. The below is only representative of some of the many permutations available.

Exemplary Tooth Tapping Table:

| Right Side | Left Side | Both Sides | Command |
|---|---|---|---|
| One Tap | — | — | Scroll Horizontally |
| Two Taps | — | — | Select a Screen or |
| | | | Option |
| — | One Tap | — | Scroll Vertically (after |
| | | | a screen has been |
| | | | selected). |
| — | Two Taps | — | Select Specific |
| | | | Function, (e.g., |
| | | | camera mode) |
| One Tap | One Tap | — | Take Picture (when in |
| | | | camera mode). |
| One Tap | — | One Tap | Start Video (when in |
| | | | camera mode). |
| One Tap | One Tap | — | Start Recording Audio |
| | | | (when in camera |
| | | | mode). |
| — | — | Three Taps | Power Down |

The computer receives the tapping sound signals from the microphone and uses controlling circuitry and, if necessary, a simple algorithm to determine the exact tap-sequence and time between taps to establish a “command signature”, which is specific to each particular tap-sequence. From this, the computer compares the command signature with a corresponding command or action stored in the onboard memory and then performs that command or action, as required. This process is somewhat similar to how a conventional computer “reads” the clicks of a conventional mouse and determines what the single click or click-combination means, and then carries out the “translated” command or action. Following the present invention, the user can effectively and discretely control many operations of the head-mounted computer merely through tooth tapping.

Applicant recognizes that a user's tooth tapping ability may change over time and during different conditions, such as during or shortly after eating, or at different times of the day. How the user wears head-mounted computer 10 may also alter the signal input of tapping teeth. To this end, Applicant contemplates having the user quickly and easily calibrate the system using a learning or calibrating program and by following a quick pattern of taps, as instructed by a calibration screen HUD 26, such as: Tap Right Side Twice, Tap Left Side Twice, Tap Both Sides Twice, etc. The computer or the user can initiate the calibration process at anytime or at set times. Right and left clicking sounds generated by the tapping of the teeth may be so distinguishable by appropriate detection circuitry that calibration is not required, especially if more than one microphone and/or vibration transducers are employed.

The user taps his or her teeth by simply opening and closing their jaw a small distance, preferably while keeping their lips closed. Since the lower jaw in a human is effectively floating in place, the user can quickly and easily tilt their jaw from the right and left side to control the left and right side tapping. Applicant has mentioned above that the canine teeth are the preferred teeth to tap primarily because they are generally the longest teeth in a human's mouth and tapping them can be easily controlled and can generate a sharp and consistent sound when tapped. However, it is possible that other teeth in the user's mouth can be used to generate unique tapping signals for controlling a computer without departing from the invention.

Applicant further contemplates providing sensors on the head-mounted frame structure to detect movement of the user's lower jaw (side to side and up and down and tightly closed) to control predetermined operations and functions and options of the computer during its use.

It is preferred that the above-described tooth-tapping mode be activated before use instead of always being active. By doing this, accidental commands during inadvertent jaw movement by the user will be minimized or eliminated.

The above-described tooth-tapping control of a computer is preferably activated and deactivated quickly and easily using an alternative input device, such as voice command, or a known gesture using touchpad input device 22, or perhaps even by tooth tapping a unique sequence.

According to another embodiment of this invention, the above-described tooth-tapping system can be used to control a cell phone or smart phone by using the microphone on the phone to detect different taps and thereby control different functions. For example, during a phone call when the user is holding the cell phone adjacent the user's mouth, the user could double tap their teeth to instruct the cell phone to announce a pre-set message in the user's ear, such as the time, the name of the called party, or perhaps other information about the called party, such as his wife's name or when the last time they spoke on the phone. Other tap-command sequences could instruct the cell phone to announce different information, depending on how the system is set up. Depending on the level of ambient noise and sensitivity of the cell phone's microphone, the tooth-tapping system may be used even when the cell phone is away from the user's mouth. Although not preferred, it is also contemplated here that the user could generate simple voice commands during a phone call to extract predetermined information from the phone. For example, the user could say the word “time” to have to phone announce the current time (or the elapsed time of the call) into the user's ear. Mouth-generated sounds is preferred here since such sounds are more subtle.

According to a third embodiment of the invention, a body-worn or head-worn device is provided that includes at least one microphone and, if possibly additional microphones and/or vibration detection transducers, preferably a power supply and a communication link to a remote computer. In this embodiment, the tapping sounds generated by the user's mouth will be detected and directly transmitted (as an electric signal) using the communication link (such as a connected signal wire, Bluetooth®, RF, Infrared diode—receiver pair, amplified sound or some other appropriate means) to the remote computer to be processed and used to generate various commands or select options, or otherwise control or change or affect a software application running on the computer. Of course, as is well understood by those of ordinary skill in the art, the signals received by the at least one microphone and/or other transducers can be electronically processed locally on the body-worn or head-worn device and a processed signal can be sent using the above-mentioned communication methods to a remote computer to control the computer, as described above. This third embodiment may be useful for controlling select commands and options when using a conventional laptop or desktop computer, and other electronic devices. One proposed application of the present invention may be to assist people who are unable to, or have difficulty in controlling keyboards, “mouse” input controllers, touch-pads or other input devices and perhaps have the added burden of not being able to speak or speak clearly.

Since sound energy can travel efficiently and effectively through dense materials, such as bone, Applicant contemplates providing a microphone or vibration-detection sensor to be worn or at least placed in mechanical contact with any part of a user's body, such as the user's wrist so that the user may employ the above tooth-tapping system to control the operation of a computer watch, for example, or any device located on the user's body. As introduced above, the device of interest may be somewhere remote to the user and the user may include a wearable controller that detects the user's tooth tapping sounds and then transmits translated controlling signals to the remote device. For example, the user could wear a watch-like electronic device on his or her wrist which would detect the user tapping their teeth. The device could translate the taps into a predetermined command or action and then transmit a corresponding command signal to a nearby television set using conventional signal-transmitting techniques, such as Bluetooth®, RF, IR, audio, laser, or other. By way of example, by tapping the left side pair of his or her canine teeth, the user could change the channel on the TV up, while right side tapping could change the channels down. Double-tapping one side could change modes, volume, “jump channels,” etc.

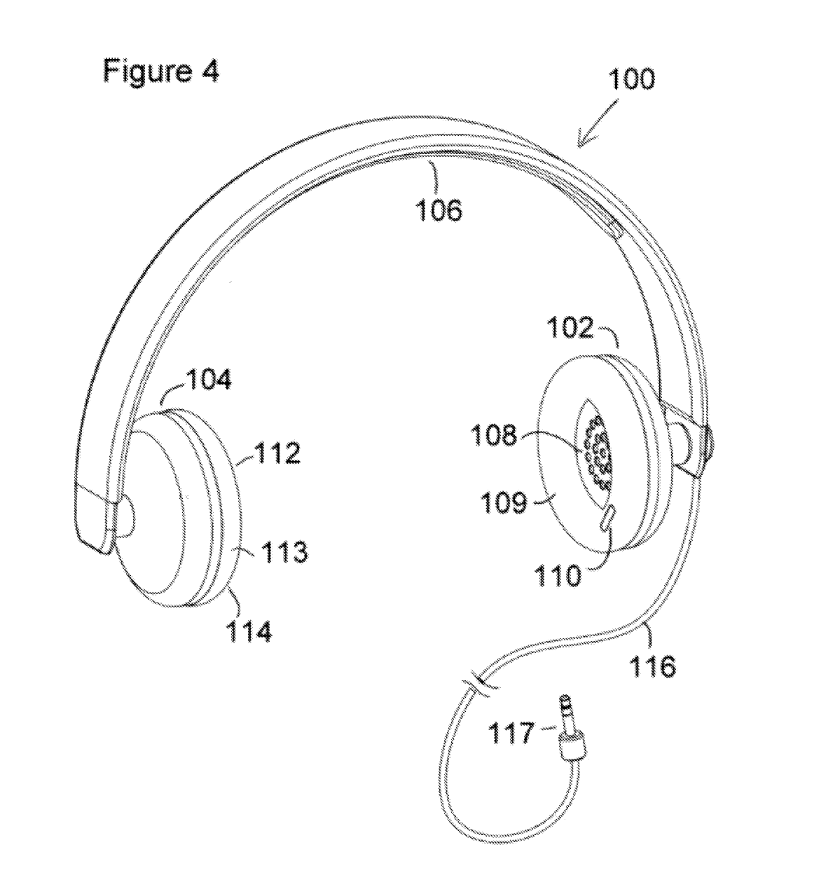

According to a fourth embodiment of the invention and referring to FIG. 4, a pair of headphones 100 is shown including a right-side housing 102, a left-side housing 104 and an interposed head-band 106 that supports the two housings 102, 104. Right-side housing 102 supports a right-side speaker 108, a right side cushion 109 and a right-side sensor (e.g., microphone, or piezo sensor) 110, while left-side housing 104 supports a left-side speaker 112, a left side cushion 113 and a left-side sensor 114.

Sensors 110, 114 can be positioned within respective housings 102, 104, but are preferably located within respective cushions 109, 113 so that they can be positioned close to the user's skin (and skull) to most clearly receive sound waves (or vibration) from the user's teeth being tapped. Applicant believes that the best location for the two sensors 110, 114 will be close to the user's jawbone, such as close to or in sound-communication with the condylar process (a portion of the human jaw that is located near each ear), but other locations may be just as suitable. The important criterion for the location of these two sensors is that each must be able to accurately and efficiently pick up the subtle mouth-generated sounds. Such mouth-generated sounds include sounds generated by the user:
a) tapping his or her teeth together (either or both sides);
b) quickly moving his or her tongue within the mouth to create clicking sounds;
c) contracting his or her cheek muscles to create air-flow sounds as air trapped in the mouth is forced to pass between two adjacent parts of the user's mouth;
d) puckering his or her lips to create kissing sounds; and
e) controlling his or her lips and teeth to create whistling sounds.

All the sounds contemplated for use with the present invention preferably originate in the user's mouth and not necessarily from the user's larynx, as is the case with voice-related sounds. However, one embodiment described below does contemplate the use of simple word commands to help control the operation of a smart phone, but when the user is speaking during a phone call.

Continuing with this forth embodiment of the invention, when a user dons headphones 100 on his or her head, both right and left speakers 108, 112 become aligned with the user's right and left ears and respective cushions 109, 113 contact the user's skin. This causes sensors 110 and 114 to firmly press against the user's skin, close to the user's skull and/or jawbone. The speakers of the headphones are electrically connected by way of a cord 116 and connector 117, to an amplified source of sound 118. Such a source of sound may include any electronic device that generates audible sound, including speaking and singing sounds and music. Such devices are well known and include, smart phones CD players, MP3 Players, iPods® and similar devices. (these devices are collectively referred to as “Source of Music”). The electrical connection is such that the user can hear the sound when it is played through the headphone speakers. Sensors 110, 114 are electrically connected to the source of music 118, preferably by way of the same cord 116 and connector 117 so that signals generated by sensors 110, 114 may be electrically processed by the connected device, as explained below.

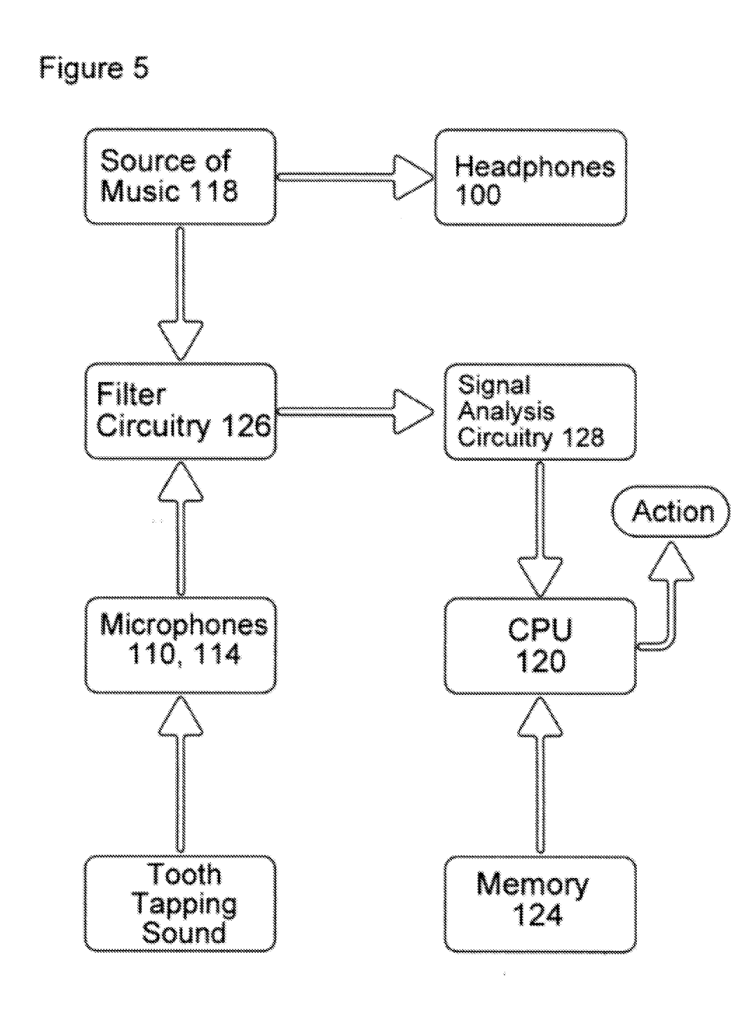

Referring now to FIG. 5, according to this embodiment of the invention and to help explain the present invention, a schematic of various components and systems of an exemplary electronic device is illustrated. The electronic device (smart phone, cell phone, CD player, MP3 player, iPod®, iPad®, etc) includes a CPU 120 that controls most operations of the device, a source of music 118, a data memory 124, filter circuitry 126, and signal analyzing circuitry 128. Of course, typical electronic devices will include several additional components and systems not mentioned here. Also, signal filter 126 and signal analyzer 128 can utilize hard circuitry, a software program, or both, as is known by those skilled in the art.

As shown in FIG. 5, both sensors 110, 114 and source of music 118 are electrically connected to filter circuitry 126, which, in turn, is connected to signal analysis circuitry 128. Source of music 118 is connected to headphones 100. In operation here, as a user wears headphones 100 and listens to music, for example, from source of music 118, the user may decide to change the music track, using the present invention. The user taps twice (at a prescribed rate) on the right side of his or her teeth, as an example. The taps are picked up by microphones 110, 114 and the sounds are converted to an electrical signal which is sent to filter circuitry 126 and signal analysis circuitry 128 where the signal is cleaned up and separated from the music signal being sent to headphones 100. Since microphones 110, 114 are positioned immediately adjacent to the speakers of headphones 100, it is likely required that the music signal will be picked up by microphones 110, 114. Filter circuitry 126 and signal analysis circuitry 128 help separate the tap sounds from the music sounds so that just the teeth taps may be electronically discerned. The “cleaned up” tap signal is then sent to CPU 120. Here, CPU 120 compares the tap signal to command signatures stored in connected memory 124. If there is a match (or a close match), CPU 120 determines the action or command that corresponds to the tap signal and carries out that action. In this example, the CPU would see that two right side tooth taps is a command signature to advance the music track. The CPU would control the required components, not described in any great detail here, to perform that commend.

The output to microphones 110, 114 also may only have to be sent directly to CPU 120, depending on how the microphones are secured to headphones 100.

Of course, there are other possible ways to carryout the present invention, as one of ordinary skill in the art would understand. As long as it is understood that when the user creates mouth sounds, for example by tapping his or her teeth, a controlling circuit located within the electronic device receives and processes the mouth-generated sounds, converting the sound signal into predetermined commands that are then used to control either the connected electronic device 118, the headphones 100, or both, or some other remote electrical device (not shown).

As an example of the above-described fourth embodiment, a female user is wearing headphones 100 and is listening to a song from a list of songs being played by a connected smart phone device. As she listens to the particular song, she decides to skip to the next song in the list. She taps her right side teeth together once and the tap sound that is created is picked up by both the right and left side microphones 110, 114. The sound signals are immediately electrically communicated along cord 116 to the controlling circuit located within smart phone device 118. Controlling circuitry (including filter circuitry 126, signal analysis circuitry 128, CPU 120 and memory 124 process the two signals (one from each microphone) and uses known audio-signal analyzing techniques to learn that the tap sound was created on the right side of her mouth. Controlling circuitry uses this information to transmit any command (or other signal or data) located in memory that corresponds to a single right tap to the microprocessor 120, which will cause other controlling circuitry to advance the song being played to the next song in the queue. Perhaps a left tap will replay the current song, which a single right tap advances the song down the list. Two right taps causes the played song to start from the beginning. Other taps and tap sequences can be used to control a variety of functions including, changing of the songs, controlling headphone volume, treble or bass, or perhaps instructing the electronic device to announce the artist of the song, or the song title (or other information) through the speakers and into the user's ears.

As mentioned above, since controlling circuitry has access to the exact sound signals of what is being played in each speaker 102, 104, the circuitry can use this information to efficiently filter out any sound from either speaker that accidentally reaches either microphone 110, 114. This will allow the microphones to more accurately pick up the relatively subtle mouth-generated sounds (such as tooth tapping) created by the user, even while load music is played through headphones 100.

Microphones 110, 114 (or other appropriate sensors), can be positioned anywhere on headphones 100, as long as they are able to pick up mouth-generated sounds of the user.

According to yet another embodiment of the invention (not shown), the above described headphone application of the invention can be applied to so-called “ear-buds” that are similar in size and appearance to a pair of hearing aids and are used by inserting a right side “bud” (which includes a micro-speaker) into the right side ear canal of the user and similarly, inserting a left side “bud” into the user's left side ear canal. According to this embodiment, each “bud” includes a small microphone that is positioned to contact the side wall of the user's right or left ear canal. The intimate contact allows tapping of the user to be picked up by the user, even if music or other is being played through the buds.

Applicant also contemplates here that the speaker housing 102, 104, or the housing of the ear buds may be tapped by the user to generate the required tap sequence to help control the electronic device. In this embodiment, the user merely has to tap the housing of the headphones (or buds) to generate a sound that gets picked up by the microphones 110, 114 and then processed as if the user generated the tap sequence using his or her mouth (e.g., teeth).

As is well known, a speaker can function as a microphone and any ambient sounds will be picked up by the speaker resulting in the speaker converting the sounds into an electrical signal. This will work even if the speaker is being used as a speaker. Based on this phenomenon and according to another embodiment of the present invention, the wearer's headphones are used to pick up the subtle mouth-generated sounds of the user (e.g., tapping his or her teeth). The speakers in the headphones will convert the tapping sounds into electrical signals which will transmit along the headphone wire and into the electronic device. The incoming tapping signal can be filtered from the outgoing sound signal (e.g., music) and otherwise analyzed to associate the tapping signal with preset commands or actions, such as advancing the song to the next song, as described above in other embodiments.

What is claimed is:

1) A method for a user to control specific operations of an electronic device of the type including a microprocessor, a memory, a battery, and a microphone, comprising the steps of:
manipulating the user's mouth to generate a sound;
using said microphone to convert the generated sound to an electric signal;
matching said electric signal with a known command to control said specific operation stored in memory; and
having said microprocessor carry out said known command to control said specific operation.

2) A method for a user to control a music-playing device of the type connected to headphones wherein music is being played to the user's ears through said headphones, said method comprising;
having the user manipulate his or her mouth to generate a sound;
converting said mouth-generated sound to an electronic signal;
comparing said electronic signal to a list of operating commands for said music playing device; and
controlling the operation of said music-playing device based on said electronic signal matching a particular operating command from said list of operating commands.
